(19) United States
(12) Patent Application Publication
(10) Pub. No.: US 2008/0302400 A1
(43) Pub. Date: Dec. 11, 2008

(54) System and Method for Removal of Materials from an Article

(76) Inventors: Thomas Johnston, Lubbock, TX (US); Timothy Vaughn, Lubbock, TX (US); Pete Atwell, Breckenridge, TX (US)

Correspondence Address: DUBOIS, BRYANT, CAMPBELL & SCHWARTZ, LLP, 700 LAVACA STREET, SUITE 1300, AUSTIN, TX, 78701, US

(21) Appl. No.: 11/844,575

(22) Filed: Aug. 24, 2007

Related U.S. Application Data
(63) Continuation of application No. 11/758,483, filed on Jun. 5, 2007, now abandoned.

(51) Int. Cl. B08B 3/00

(52) U.S. Cl. 134/58 R

(57) ABSTRACT

The system and method of the present invention removes organic and organometallic materials from an article in reduced pressure atmosphere containing ozone and activated oxygen. A dielectric barrier discharge lamp induces an intermolecular molecule energy transfer to the organic and organometallic material. The dielectric barrier discharge lamp emits vacuum ultraviolet rays having a wavelength of about 172 nm that produce a photochemical reaction with the oxygen-containing gas to generate ozone and the activated oxygen. The organic and organometallic material is then attached by the ozone and activated oxygen

### CROSS-REFERENCE TO RELATED APPLICATIONS

The present application is a continuation-in-part of, and incorporates by reference, U.S. Utility patent application Ser. No. 11/758,483, filed on Jun. 5, 2007 entitled “System and Method for Removal of Materials from an Article” which claims priority from and incorporates by reference prior U.S. Utility patent application Ser. No. 11/395,500, filed on Mar. 31, 2006 entitled “System and Method for Removal of Materials from an Article” which claims priority from and incorporates by reference prior U.S. Utility patent application Ser. No. 10/667574, filed on Sep. 22, 2003 entitled “System and Method for Removal of Materials from an Article” which claims priority from and incorporates by reference prior U.S. Provisional Patent Application No. 60/412604, filed Sep. 20, 2002 entitled “Method and System for Oxidizing an Article at Low Pressure.”

### BACKGROUND OF THE INVENTION

1. Field of the Invention

The system and method of the present invention pertains to the manufacture of articles; more particularly, the removal of organic and organometallic materials from an article.

2. Description of the Related Art

Ultraviolet systems from removing organic material such as polymers and photoresist from articles have been used from many years. Historically, most of the UV systems for removing organic or organometallic materials from articles have involved the use of 254 nm and 184 nm mercury lamp systems. In recent years, the development of systems for removing organic materials from an article has focused more on the use of dielectric barrier discharge lamps such as shown in U.S. Pat. No. 5,510,158. These dielectric barrier discharge lamps are xenon lamps that emit light at 172-nm wavelength. It has been shown that ozone and activated oxygen can be produced by combining an oxygen-containing gas at a pressure of one atmosphere in the presence of xenon 172-nm wavelength source. It has also been shown that the production of ozone and activated oxygen for the use in the oxidation process consumes a large portion of the energy produced by 172-nm xenon wavelength source.

U.S. Pat. No. 6,409,842 discloses a process for cleaning of substrate surfaces, or coating substrate surfaces, by irradiating a surface with a radiation wavelength between 60 nm and 350 nm emitted from dielectric barrier discharge lamps in which the substrate to be cleaned is placed in a vacuum. The UV radiation devices described in this patent are conventional lamps and there is no discussion of the use of a UV lamp capable of withstanding sub-atmospheric pressure. Although at one point the inventors disclose that “it is possible . . . to perform the process in a vacuum or reduced pressure,” they quickly qualify this teaching with the statement “in which case, the substances being used in forming the radical molecules are placed in the area between the ultraviolet radiator and the substrate surface.” This qualification is necessary because the lamp and the substrate are not intended to both be placed in the vacuum chamber.

U.S. Pat. No. 6,631,726 similarly discloses an apparatus and method for cleaning a substrate using a dielectric discharge lamp in the presence of a moistened inert gas. As with other teachings in the art, however, the cleaning process is performed in an open chamber with “entrance and exit openings which are provided at upstream and downstream ends.”

In summary, while the prior art discloses the use of 172 nm ultraviolet light to clean a substrate and also discloses the placement of the substrate in a vacuum during the cleaning process, it does not disclose the placement of both the ultraviolet light and the substrate in the same vacuum chamber. There is a need, therefore, for a method and system which provides for the placement of both the lamp and the substrate in a vacuum chamber.

When organic or organometallic materials are located on the sidewalls of an article, removal of these materials is typically accomplished in a wet chemistry environment. The removal of organic or organometallic materials from an article in a wet chemistry environment can produce surface damage to the article as well as create hazardous byproducts. There is a need therefore, for a process capable of removing materials from an article in an environment other than a wet chemistry environment.

The need remains for a commercially effective dry environment system and method that effectively removes organic or organometallic materials from the surface and sidewalls of an article at a rapid rate.

### SUMMARY OF THE INVENTION

The system and method of the present invention facilitates the dry environment removal of organic or organometallic materials, such as a polymer created by the semiconductor etching process an photoresist materials, from the surface and sidewalls of an article without the use of wet chemistry or standard atmospheric oxidative processes.

An article with organic or organometallic materials, such as a polymer or photoresist, located thereon is placed into a vacuum reaction chamber. The vacuum reaction chamber contains an oxygen-containing gas at a reduced pressure of between about 50 mtorr to about 1500 mtorr. Located within the vacuum reaction chamber is an irradiation source. Typically, the irradiation source is a xenon gas dielectric barrier discharge lamp, which emits vacuum ultraviolet rays having a wavelength of about 172 nm. It is essential that the irradiation source have the ability to withstand the low-pressure conditions within the vacuum reaction chamber.

The 172 nm xenon wavelength induces an intermolecular molecule energy transfer, thereby destroying the molecular bond of the organic or organometallic material. The 172 nm energy in the presence of oxygen-containing gases creates ozone and activated oxygen. The products resulting from the destruction of the molecular bonds are then oxidized by the ozone and activated oxygen. The volatile byproducts created from this reaction with ozone and activated oxygen are abated from the article surfaces via the vacuum system. In addition to the removal of the reaction byproducts, the vacuum increases the amount of 172 nm energy at the surface of the article resulting in an increase in the overall reaction rate.

One advantage of the present invention over the prior art is the elimination of the need for wet chemistry in the removal or organic or organometallic materials, thereby eliminating the need for expensive solvents and environmentally destructive and potentially hazardous byproducts. Another advantage is the elimination of the use of plasma-based photoresist removal processes, thereby eliminating the potential for damage from electrostatic charging commonly found in plasma-based ashers. Yet another advantage is the increase in the overall reaction rate which is highly beneficial in a commercially viable post-etch cleaning process for semiconductor and reticle manufacturing.

### BRIEF DESCRIPTION OF THE DRAWING

A better understanding of the system and method of the present invention may be had by reference to the drawing figure, wherein:

FIG. 1 is schematic view of a vacuum reaction chamber containing a dielectric barrier discharge lamp.

### DETAILED DESCRIPTION OF PREFERRED EMBODIMENTS

A better understanding of the present invention may be had by understanding that the ultraviolet photodissociation process produces high molecular breakdown rates of both organic and organometallic materials from the surface of article. The use of a xenon 172 nm wavelength lamp fragments hydrocarbon bonds by the process of intermolecular molecule energy transfer. This method of fragmenting of hydrocarbon bonds, as opposed to an oxidation method, allows for smaller, more volatile species to form at the reaction surface, thereby improving upon the use of an oxidative process for the removal of unwanted organic materials from the surface of the article.

It has been found that the placement of xenon 172 nm dielectric barrier discharge lamp directly into a vacuum reaction chamber allows the surface of an article within the vacuum reaction chamber to receive higher levels of energy than at atmospheric pressure. The receipt of these higher levels of energy was unattainable in atmospheric conditions because of the majority of energy transferred by the xenon 172 nm dielectric barrier discharge lamp was to the gas phase molecules (N₂ and O₂). It has been discovered that the use of a xenon 172 nm dielectric barrier discharge lamp at very low pressures from about 50 mtorr to about 1500 mtorr allows for an extended life of activated oxygen, which is produced by a xenon 172 nm dielectric barrier discharge lamp (O₃→O₂+O) or (2O₂→O₃+O). The production of activated atomic oxygen O, which is a strong oxidizing agent, accelerates the overall reaction rate and creates a volatile species, which is removed by the vacuum system. The ozone O₃ and activated atomic oxygen O react with the organic and organometallic materials that have broken bonds via the intermolecular molecule energy transfer from the xenon 172 nm dielectric barrier discharge lamp.

In another embodiment of the present invention, gases that contain combinations of one or more of oxygen, fluorine, chlorine, and bromine such as, for example, tetraflouromethane or triflouromethane may be introduced into the vacuum reaction chamber. These gases or combination of gases in the presence of the lamp can create reactive fragments which in turn will react with treated surface that can contain either organic or organometallic compound. These reactions will produce inert and volatile byproducts. This method of fragmenting of hydrocarbon bonds, further improves upon the use of an oxidative process for the removal of unwanted organic materials from the surface of the article

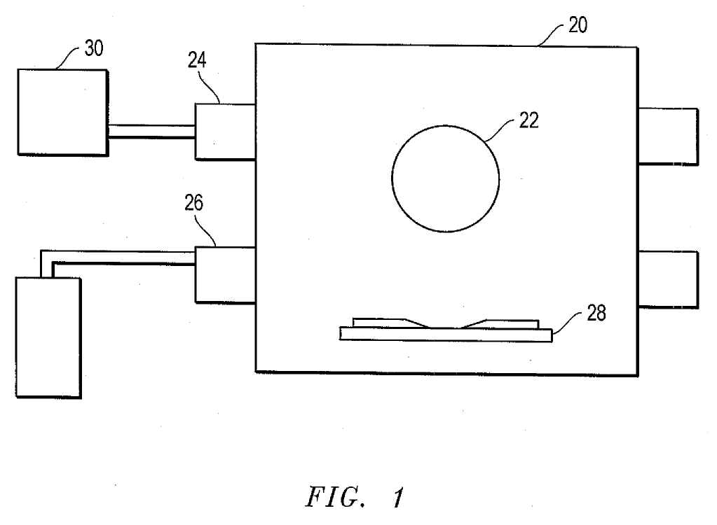

To implement the use of a xenon 172-mn dielectric barrier discharge lamp in a vacuum reaction chamber, the lamp must have the structural strength to be placed in a low-pressure environment and encapsulate the xenon gas in an excimer state. In the preferred embodiment, and as shown in FIG. 1, a vacuum reaction chamber 20 is constructed with single or multiple lamp 172 nm lamp sources 22, vacuum inlet ports 24, particle gas inlet ports 26, a single wafer or reticle stage 28, and TC or thermogauge inlets 30. The system for producing vacuum within the vacuum reaction chamber 20 includes a two-stage 300 L/min pump 30 or some variation thereof.

In the preferred embodiment of the system described, the photodissociation process caused by the UV light source performs the below resist etches.

The system and method of the present invention removes polymers created by the metal etch process along with the complete removal of the photoresist material such as a SPR-700 Shipley photoresist material. In one example, a silicon wafer that contains a 1K of titanium, 3K of titanium tungsten, plus 6K of aluminum with 0.5% copper (1KTi/3K TiW w/6 K Al Cu 0.5%) was etched with a Lam Researcher Corporation etcher with no pacification process. Although the material used in this example was silicon, it could be quartz or any other material used in the semiconductor manufacturing process.

The system and method of the present invention not only removes sidewall polymer and photoresist material from the surface of the article in a dry environment, but allow for such removal without damaging the article surfaces.

While the present system and method has been disclosed according to the preferred embodiment of the invention, those of ordinary skill in the art will understand that other embodiments have also been enabled. Such other embodiments shall fall within the scope and meaning of the appended claims.

We claim:

1. A system for removing organic or organometallic materials from an article comprising:
an enclosed vacuum reaction chamber constructed and arranged to contain an article having organic or organometallic materials located therein;
said enclosed vacuum reaction chamber, wherein the vacuum pressure within said enclosed vacuum reaction chamber is between about 50 mtorr and about 1500 mtorr;
one or more lamps for emitting vacuum ultraviolet radiation having a wavelength of about 172 nm contained within said enclosed vacuum reaction chamber, said one or more lamps being capable of operating at low pressures; and
wherein said one or more lamps are positioned in relation to said article so as to facilitate the removal of unwanted matter from said article.

2. The system of claim 1 wherein the gas in said enclosed vacuum reaction chamber is one or more of oxygen, flourine, chlorine, and bromine.

3. A system for removing organic and organometallic materials from an article comprising:
a vacuum reaction chamber in which the vacuum pressure is from about 50 mtorr to 1500 mtorr, said vacuum reaction chamber containing at least one article having organic or organometallic materials located thereon;
one or more lamps for emitting vacuum ultraviolet radiation having a wavelength of about 172 nm contained within said vacuum reaction chamber, said one or more lamps being capable of operating at low pressures; and
wherein said one or more lamps are positioned in relation to said article so as to facilitate the removal of unwanted matter from said article.

4. A system for removing the organic or organometallic material from an article in a dry environment, said system comprising:
an enclosed vacuum reaction chamber constructed and arranged to contain an article having organic or organometallic material on its surface or on its sidewalls, wherein the vacuum pressure in said enclosed vacuum reaction chamber is between about 50 mtorr and about 1500 mtorr; and
one or more irradiation device for emitting vacuum ultraviolet radiation having a wavelength of about 172 nm contained within said enclosed vacuum reaction chamber, said one or more devices being capable of operating in low pressures; and
wherein said one or more irradiation devices are positioned in relation to said article so as to facilitate the removal of unwanted matter from said article.
